(19) United States
(12) Patent Application Publication
(10) Pub. No.: US 2010/0269654 A1
(43) Pub. Date: Oct. 28, 2010

(54) Dust Collection System for a Power Tool

(76) Inventors: Gregory E. Needel, Jackson, TN (US); Patrick W. Middleton, Medina, TN (US)

Correspondence Address: THE BLACK & DECKER CORPORATION, 701 EAST JOPPA ROAD, TW199, TOWSON, MD, 21286, US

(21) Appl. No.: 12/431,099

(22) Filed: Apr. 28, 2009

(51) Int. Cl. B23D 59/00

(52) U.S. Cl. 83/100

(57) ABSTRACT

A power tool having a base, a table disposed on the base, and a saw assembly attached to at least one of the base and the table. The saw assembly includes at least a cutting tool extending through the table and a dust exhaust disposed adjacent to the cutting tool. A hose is connected to the dust exhaust at one end. A dust port assembly is disposed on the base. The dust port assembly has a first input port connected to the hose, a second input port open to the base, and a first output port.

### FIELD

This invention relates generally to power tools and, more particularly, to dust collection systems on table saws.

### BACKGROUND

Generally, a table saw for cutting work pieces has a table and a saw assembly beneath the table. The saw assembly carries a blade, which can cut through or into a workpiece. During the cutting operation, saw dust, wood chips and other debris is directed into the housing of the table saw.

Dust confining and collecting housings and enclosures as well as other dust collection systems for table saws and similar power cutting tools have been disclosed in the prior art. Examples thereof may be found in U.S. Pat. Nos. 7,036,412, 7,000,515, 6,925,919, 6,792,208, 6,530,303, 5,158,001, 4,255,995, 4,063,478, 4,367,665, and 2,044,481, and US Publication Nos. 2007/0151433, 2006/0201302, 2006/0201301, and 2006/0101958.

It is desirable to collect the dust, chips and/or debris directed into the housing so as to minimize the amount of dust, chips and/or debris that may escape from the housing into the atmosphere.

### SUMMARY

In accordance with the present invention, an improved power tool is employed The power tool comprises a base, a table disposed on the base, a saw assembly attached to at least one of the base and the table, the saw assembly comprising at least a cutting tool extending through the table and a dust exhaust disposed adjacent to the cutting tool, a hose connected to the dust exhaust at one end, and a dust port assembly disposed on the base, the dust port assembly having a first input port connected to the hose, a second input port open to the base, and a first output port.

Additional features and benefits of the present invention are described, and will be apparent from, the accompanying drawings and the detailed description below.

### BRIEF DESCRIPTION OF THE DRAWINGS

The accompanying drawings illustrate preferred embodiments of the invention according to the practical application of the principles thereof and in which:

FIG. 1 is a front elevational view of an exemplary table saw according to the present invention;

FIG. 2 is a side elevational view of the saw assembly;

FIG. 3 is a front perspective view of the saw assembly;

FIG. 4 is a rear perspective view of the saw assembly; and

FIG. 5 is a partial exploded perspective view of a dust port assembly.

### DETAILED DESCRIPTION

The invention is now described with reference to the accompanying figures, figures, wherein like numerals designate like parts. Persons skilled in the art are also referred to U.S. Pat. No. 6,530,303, which is hereby incorporated in whole by reference.

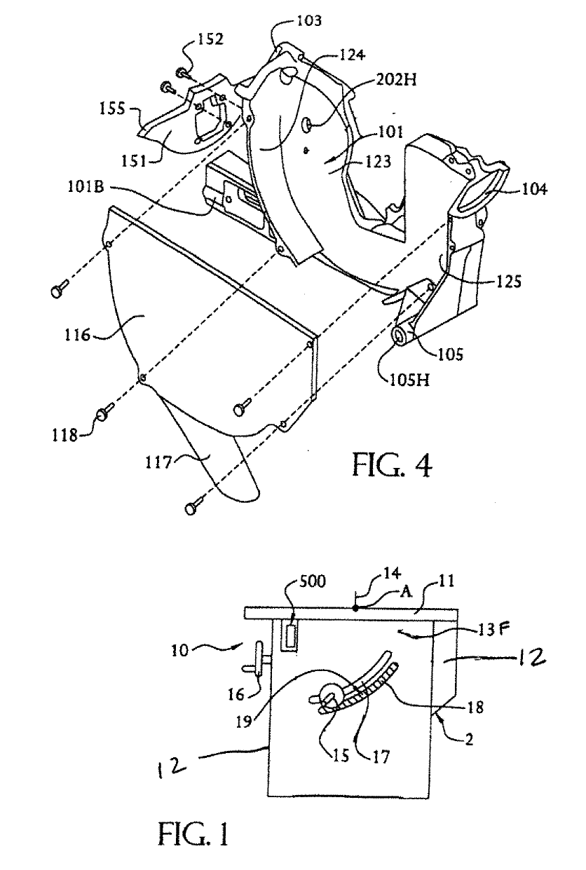

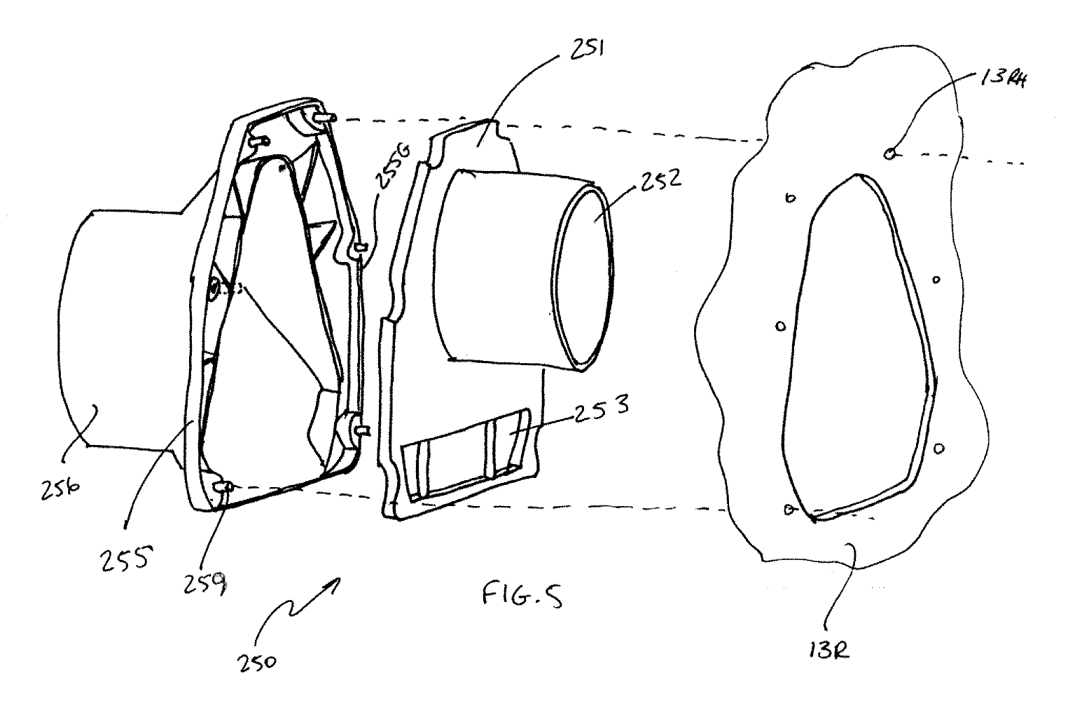

FIGS. 1-5 show an exemplary power tool 10. Power tool 10 may be a sander, a shaper, or any other power tools that have a rotatable cutting tool extending upwardly from a table. Preferably, power tool 10 is a table saw with a table 1, and a base assembly 2 supporting the table 11. Base assembly 2 may have a front panel 13F connected to table 11, side panels 12 disposed adjacent to front panel 13, and a rear panel 13R disposed between side panels 12.

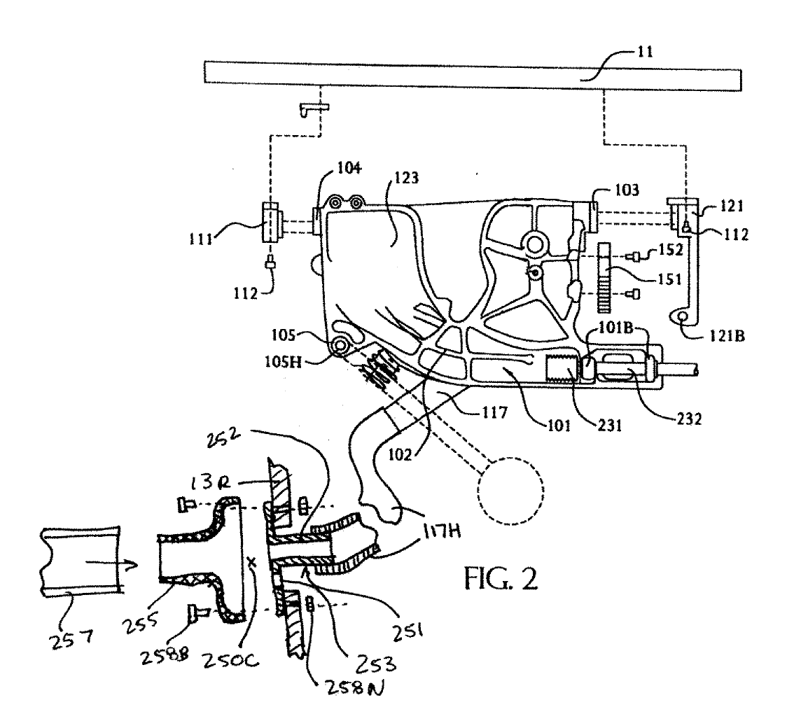

Referring to FIGS. 2-4, a saw assembly 100 is preferably pivotally attached underneath the table 11. Saw assembly 100 carries a rotatable cutting tool, such as blade 14. Saw assembly 100 may include a cradle 101. Cradle 101 is preferably made of cast iron to absorb vibration and/or reduce noise.

Preferably cradle 101 has a side wall 123, a front wall 124 and a rear wall 125. A removable side cover 116 may be also attached to cradle 101 via bolts 118. Preferably side cover 116 is made of plastic and may have a dust exhaust port 117 disposed thereon, to direct dust created throughout the cutting operation. Dust exhaust port 117 may be connected to a hose 117H. Persons skilled in the art will recognize that the side cover 116 may have front and/or rear walls 124, 125.

Ribs 102 may be disposed on side wall 123 and/or cradle 101 to increase rigidity and strength while adding minimal weight.

Persons skilled in the art will recognize that the cradle/side cover combination has a generally U-shaped cross-section. Blade 14 is preferably disposed between side cover 116 and side wall 123.

Cradle 101 may have a front arcuate track 103 and a rear arcuate track 104. These tracks 103, 104 are slidably received by grooves in front trunnion bracket 121 and rear trunnion bracket 111, respectively, which are attached to the underside of table 11 via bolts 112. Such connection allows the cradle 101 to be rotated about a substantially horizontal axis A, thus allowing the operator to change the angle of blade 14 relative to table 11, i.e., the bevel angle. The horizontal axis A is preferably co-planar to table 11.

Persons skilled in the art will recognize that tracks and grooves may be alternately disposed on he trunnion brackets and the cradle 101, respectively. Persons skilled in the art will also recognize that the cradle 101 may be pivotally attached to the front panel 13, legs 12 or other parts of base assembly 2.

Cradle 101 may also have a pivot joint 105, for pivotally attaching bracket 108 to cradle 101. Pivot joint 105 may have a hole 105H extending through cradle 101. Preferably, bracket 108 has two side walls with holes, so that a pin 105P can extend through the first wall, hole 105H and the second wall. Preferably bearing sleeves 105L are disposed between hole 105H and pin 105P, to minimize friction therebetween. A retainer clip 105R can then be used to maintain pin 105P in place.

Bracket 108 is preferably welded to the housing of motor 109. Persons of ordinary skill in the art will recognize that bracket 108 may be attached to motor 109 via screws, etc. Bracket 108 may have a hole (not shown) therewith to allow dust exhaust port 117 to extend therethrough.

Motor 109 is preferably electric and may be a universal electric motor, an induction motor or switched reluctance motor. Preferably, saw assembly 100 is designed so that motor 109 is wholly disposed within base assembly 2 an or underneath table 11. Motor 109 may drive a shaft 113, which in turn drives a pulley 114. A belt 115 drivingly connects pulley 114 to pulley 201 in arbor assembly 200, which is explained in more detail below.

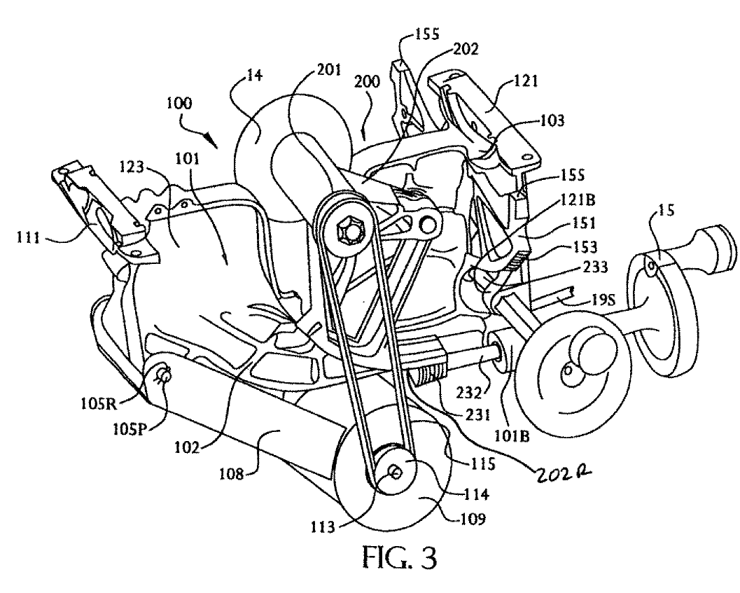

Referring to FIG. 3, saw assembly 100 preferably comprises an arbor assembly 200. Arbor assembly 200 may include an arbor bracket 202, which is preferably pivotally attached to cradle 101 via hole 2021. Arbor bracket 202 rotatably supports arbor 203. Blade 14 is disposed on arbor 203. Accordingly, the height of blade 14 relative to the table 11 can be adjusted by rotating arbor assembly 200.

Such blade adjustment can be accomplished by providing arbor bracket 202 with a rack 202R. This rack 202R meshes with a worm drive 231 disposed on height shaft 232, which is rotated via height crank wheel 15. Height shaft 232 is supported by two protrusions 101B of cradle 101, in a manner discussed more fully below. Accordingly, height shaft 232 and worm drive 231 rotate when height crank wheel 15 is rotated. Worm drive 231 meshes with rack 202R, causing arbor bracket 202 (and arbor assembly 200) to rotate, changing the height of blade 14.

The angle of blade 14 relative to table 11 may be changed in a manner similar to the blade height. Preferably cradle 101 is provided with a bevel sector gear 151 thereon. Preferably, bevel sector gear 151 is attached to cradle 101 via screws 152. Bevel sector gear 151 has a rack 153 which meshes with a worm drive (not shown) disposed on bevel shaft 233, which is rotated via bevel crank wheel 16. Bevel shaft 233 is supported by two protrusions 121B of front trunnion bracket 121, in a manner similar to the mounting of height shaft 232. Accordingly, bevel shaft 233 and its worm drive rotate when bevel crank wheel 16 is rotated. The worm drive meshes with rack 233, causing cradle 101 and blade causing cradle 101 and blade 14 to rotate, thus changing the bevel angle of blade 14 relative to table 11.

Bevel sector gear 151 may also have bevel stop surfaces 155, which contact the underside of table 11 or bevel stop bolts threadingly engaged to table 11. Accordingly, as cradle 101 is beveled, bevel sector gear 151 is also beveled. When one of the limits of the bevel angle range, e.g., from about 0° to 45°, is reached, bevel stop surface 155 will contact the underside of table 11 or a bevel stop bolt, preventing any further bevel movement.

Referring to FIGS. 2 and 5, it is preferable to provide table saw 10 with a dust port assembly 250. Dust port assembly 250 is preferably disposed on rear panel 13R. However persons skilled in the art will recognize that dust port assembly may be placed on side and front panels 12, 13F.

Dust port assembly 250 may have an inner port assembly 251. Inner port assembly 251 preferably has an input port 252, which is connected to hose 117H. Inner port assembly 251 preferably also has a window 253. Persons skilled in the art will recognize that dust and debris floating around the inside of base 12 can go through window 253, while dust and debris directed into hose 117H will go through input port 252.

Dust port assembly 250 may have an outer port assembly 255 with an output port 256. Outer port assembly 255, input port assembly 251 and/or rear panel 13R form a chamber 250C, where the only inputs are input port 252 and window 253 and the only output is output port 256. With such arrangement, a user can connect a hose 257 to output port 256 and to a vacuum source (not shown), to collect any dust or debris within chamber chamber 250C. Persons skilled in the art will recognize that such vacuum source will aid in the collection of dust and debris floating around the inside of base 12 (which would go through window 253).

Referring to FIG. 2, dust port assembly 250 may be disposed on rear panel 13R as follows. First, inner port assembly 251 may be inserted through and disposed on rear panel 13R. Outer port assembly 255 may be disposed over inner port assembly 251. The dust port assembly 250 can then be held in place by bolts 258B entering through outer port assembly 255, inner port assembly 251 and rear panel 13R and threadingly engaging nuts 258N. Alternatively the dust port assembly 250 can be held in place by bolts 258B entering through outer port assembly 255, inner port assembly 251 and threadingly engaging rear panel 13R. Persons skilled in the art will recognize that dust port assembly 250 can be securely mounted to rear panel 13R with other means such as adhesives, rivets, etc.

Alternatively, outer port assembly 255 may have snap-on fasteners 259 (FIG. 5) that bypass inner port assembly 251 and engage holes 13RH in rear panel 13R. Providing such arrangement would facilitate assembly of dust port assembly 250, as the entire assembly could be installed from the outside of rear panel 13R.

Persons skilled in the art will recognize that it may be advantageous to provide an O-ring or rubber gasket 255G on at least one of the inner port assembly 251, outer port assembly 255 and rear panel 13R to minimize gaps in chamber 250 and minimize the amount of dust that could escape therefrom. As shown in FIG. 5, O-ring or rubber gasket 255G is preferably disposed on outer port assembly 255 to ensure a good seal between outer port assembly 255 and rear panel 13R.

Persons skilled in the an may also recognize other alternatives to the means disclosed herein. However, all these additions and/or alterations are considered to be equivalents of the present invention.

We claim:

1. A power tool comprising:
a base;
a table disposed on the base;
a saw assembly attached to at least one of the base and the table, the saw assembly comprising at least a cutting tool extending through the table and a dust exhaust disposed adjacent to the cutting tool and below the table;
a hose connected to the dust exhaust at one end; and
a dust port assembly disposed on the base, the dust port assembly having a first input port connected to the hose, a second input port open to the inside of the base, and a first output port;
wherein the first input port receives dust from the dust exhaust, and the second input port receives dust from the inside of the base.

2. The power tool of claim 1, wherein the cutting tool is a blade.

3. The power tool of claim 1, wherein the dust port assembly comprises an outer port assembly that includes the first output port.

4. The power tool of claim 3, wherein the outer port assembly is connected to the base.

5. The power tool of claim 4, wherein the dust port assembly comprises an inner port assembly that includes the first input port.

6. The power tool of claim 5, wherein the inner port assembly is disposed on the base.

7. The power tool of claim 6, wherein at least two of the base, inner port assembly and outer port assembly define a chamber.

8. The power tool of claim 7, wherein at least one of the base, inner port assembly and outer port assembly has a gasket to remove gaps between the least one of the base, inner port assembly and outer port assembly and another of the base inner port assembly and outer port assembly.

9. The power tool of claim 8, wherein the first output port is connectable to a vacuum source.

10. The power tool of claim 9, wherein the outer port assembly has fasteners connectable to the base.
